(19) United States
(12) Patent Application Publication
(10) Pub. No.: US 2026/0234913 A1
(43) Pub. Date: Aug. 13, 2026

(54) FOG COLLECTOR THAT CAN REDUCE THE GRAVITATIONAL LOSS OF CAPTURED WATER, WITH FACILITATED TRANSPORT IN A FOLDED OR ROLLED STATE

(71) Applicants: PONTIFICIA UNIVERSIDAD CATOLICA DE CHILE, Santiago (CL); DESMONTABLES S.A.

(72) Inventors: Pablo Eugenio OSSES MCINTYRE, Santiago (CL); Osvaldo Francisco SOTOMAYOR ROJO, Santiago (CL); Gonzalo Galo RODRÍGUEZ WHIPPLE, Santiago (CL)

(73) Assignees: PONTIFICIA UNIVERSIDAD CATOLICA DE CHILE, Santiago (CL); DESMONTABLES S.A., Santiago (CL)

(21) Appl. No.: 18/726,339

(22) PCT Filed: Dec. 23, 2021
(86) PCT No.: PCT/CL2021/050125

§ 371 Date: Jan. 17, 2025

(51) Int. Cl. E03B 3/28; B01D 39/08; B01D 46/00; B01D 53/26

(52) U.S. Cl. CPC E03B 3/28; B01D 39/083; B01D 46/0001; B01D 46/0005; B01D 46/0031; B01D 53/266; B01D 2257/80; B01D 2265/04; B01D 2265/06; B01D 2279/40

(57) ABSTRACT

Fog water collector (1) consisting of a mesh-type capture component (A) and a support component (B); capable of reducing the gravitational loss of water and facilitating its transfer in a folded or rolled state ; it comprises a mesh panel (10) with a perimeter edge (101) fixed in a pre-elongated state in a flexible perimeter frame formed by stabilizing bands (12) and mounting bands (13), the stabilizing bands (12) being of a non-extensible flexible sheet material that is joined by means of fusion and sewing to said perimeter edge (101) in a pre-elongated state; meanwhile, the mounting bands (13) are formed by a body of a non-extensible flexible sheet material folded along itself at a longitudinal folding edge (131), joined with fusion means along each one of said stabilizing bands (12); and where the material of the stabilizing bands (12) and the mounting bands (13) has a lower elasticity module than the elasticity module of the mesh panel material (10).

The present invention is inserted in the field of environmental engineering and use of natural resources and is related to technologies aimed at capturing humidity from the environment to generate water resources; specifically, the present invention relates to a fog water collector that improves the collection rate in environments subject to strong winds.

### DESCRIPTION OF THE STATE OF THE ART

Two-thirds of the world's population faces water scarcity or the difficulty of clean water availability for domestic or agricultural use either due to the natural climatic conditions of a region or due to the lack of low-cost technologies that allow implementation suitable in areas of low economic availability.

The idea of capturing environmental humidity to provide water is already known especially in places where geographical and climatic conditions generate fog currents from which water can be extracted, since the water droplets can be separated from said fog or other aerosols under the right conditions.

Fog collection is a useful technique for obtaining fresh water in arid regions and there are a variety of fog collection systems designed to capture water present in the air; most of these types comprise mesh fabrics arranged on posts or frame type racks, whose operation principle is based on the wetting of the mesh thanks to fog, where small droplets adhere to the filaments of the fabric that is introduced as a separator element in the fog flow, they agglomerate there to form larger droplets until the gravitational force exceeds the bond strength and droplets are transported along the fabric filaments in the direction of gravity; normally, along the lower part of the mesh, a channel is arranged to collect the captured water, which is associated with a container to accumulate it.

This type of technology is usually very useful in regions with water scarcity and few economic resources to provide pipe installations that carry water from a source to remote places, especially when its use is intended for low-scale agricultural purposes; in these cases farmers are forced to look for other low-cost solutions that allow them to have a water resource either for use in their crops or animal husbandry, as well as sometimes for human consumption.

The use of fog collectors is affected by several factors, one of the most relevant being the size of the facilities, since the amount of captured water depends largely on the size of the collecting surface exposed to the direct passage of fog flows, so that the facilities have large dimensions with mesh panels that may easily reach 4 to 5 meters long by 3 meters high.

On the other hand, this condition given by the necessary size is affected by another relevant factor, the presence of the wind necessary for the movement of masses loaded with moisture; given that the areas where the best capture results are obtained are precisely those geographically exposed to the wind, and most of the time, exposed to strong winds.

The condition that they must be large in size translates, among other things, into difficulties in their installation because there are regions where, although the climatic conditions are optimal for installing fog collectors, such as in arid areas near a coastal edge that carries moisture-laden winds, in turn, they are isolated or high-altitude regions; so sometimes there is the limitation of not having easy access to move the collector parts to the final installation area; in this sense, a large fog collector that requires the mesh to be very tight for its optimal operation is prevented from being properly assembled at a manufacturing site and then transported armed and tensioned to the installation point; in this way, the stretching and tensioning of the mesh is usually carried out at the very moment of its installation on the supporting structure previously assembled on the ground.

The main undesired effect of this situation is that, in the case of large installations, it is very difficult to achieve a good final stretching of the mesh, so it remains loose, favoring strong winds to generate specific tensions in the mesh at the connection points with the pillars and tensors, leading to premature breakage that reduces the useful life of the mesh. At the same time, these tension shocks in the mesh generate excessive vibrations that finally result in the water droplets captured in the fabric breaking off and failing to be trapped by the system.

On the other hand, although the capture mesh must be installed as taut as possible, this ideal tension is usually compromised for several reasons, the most frequent being the installation at a height that does not allow it to be tensioned homogeneously; differences in the tension applied from one side and the other; the weather conditions of the moment; the means of joining the mesh to the support structure; a manufacturing of inappropriately larger size or of a different geometry, which at the time of installation simply does not allow it to be stretched.

The consequences of a capture mesh that is not properly stretched brings with it disadvantageous results in the final water collection rate, since due to the simple principle of operation, the captured droplets descend by gravity through the mesh fabric, so it must favor the downward displacement of the drops; however, an inadequate arrangement of the warp and woof of the fabric can cause the droplets to become trapped in the fabric, instead of quickly descending to the collecting channel as it happens when an irregular tension between the warp and woof of the mesh generates lines of horizontal folds that act as barriers to the gravitational advance of the drops.

Even leaving the mesh as flat as possible without transverse folds, one of the most determining problems in the decrease of the collection rate is caused by the loss of the poise or verticality of a poorly sized, poorly stretched or untensioned mesh that is subjected to the wind, as it produces bagging; normally this occurs because the meshes are stretched unevenly at the time of installation in the support structure, as mentioned above, and given the size and shape of the support structures it is difficult to apply the large forces that are necessary to achieve a projected and homogeneous tension of the mesh, so that it is always loose or with a margin of clearance that, when exposed to the wind, generates a curvature or bagging that favors the gravitational loss of the trapped drops, those that instead of going down the mesh fall outside the vertical line before reaching the lower channel.

It is important to note that the problem of bagging is due to poor assembly or tensioning of the mesh, but also to poor design in the sense that the mesh must have an adequate geometry. The mesh is very elastic so it must be designed smaller than the space it must occupy in the supporting structure, in order to assume part of the elastic deformations at the time of assembly and prior to receiving the wind load.

This problem caused by wind and the lack of optimal stretching of the mesh is a problem that has been addressed in different ways in the state of the art; some solutions aim to segment the size of the module formed by the mesh, so that instead of arranging a large panel between two main pillars, they propose blocks with angled faces that, in short, can offer a capture surface equivalent in size, however they require the installation of several units to achieve equal performance.

An example of this can be seen described in the Spanish Patent document ES2577680A1 by Ricardo Gil Casanova, which refers to a device for collecting atmospheric water and which was published on 18/07/2016, where a prismatic module with a rectangular section is proposed with a set of meshes on its exterior walls and a set of parallel interior walls.

Although this solution solves the problem of wind effects by segmenting the exposed planes, it has the disadvantage of its complexity and manufacturing costs due to the number of pieces it requires, and yet the result of this type of installations is usually inefficient, since the module planes that are not exposed perpendicularly or directly in contact with the fog flows have much less capture capacity.

The same happens with the solution proposed in document WO2020094248A1 from TINNIT TECH GMBH of German origin which refers to a module, a modular collector and a field of water collectors which was published on 14/05/2020; this document also proposes segmentation into smaller modules that allow for better coping with the wind, allowing for optimized maintenance because each mesh module may be replaced independently; each module comprises vertical pillars and curved horizontal crossbars to which the upper and lower edges of the mesh panel are mounted; in order to avoid bagging of the mesh it has a series of vertical tensioners spaced apart; for each modular collector it has at least two modules one on top of the other, and to optimize the result it is proposed to arrange a group of modular collectors forming an open field of collectors.

The disadvantage that can be seen in this solution is that, like the previous one, its manufacturing and installation costs are very high, not only due to the number of pieces required, but also due to the shape of the pieces, since it requires placing a curved channel under each module, and for each collector there are at least two modules, ideally five; plus the number of vertical tensioners to avoid bagging; added to this the need to cement each of the modular collectors to form a central collector that provides performance.

A very similar fact is found in the Application WO2019013654A1, of Peruvian Priority by Alberto Tejada Herrera, which deals with a fog collector or device to collect water present in the atmosphere, published on Mar. 9, 2020; similar to the previous case, it describes modules that can be grouped to form a larger collector, each module is flat, hexagonal in shape and has collector channels in the side and bottom profiles; it has rear fastening elements that allow each module to be mounted on a wall or has pillars to cement them to the ground. In this case, these are also smaller modules that, in order to achieve a greater amount of collection, must increase the number of modules; which translates again into the disadvantage of the economic cost and the complexity of manufacturing with such special parts.

Another type of existing solution that seeks to avoid mesh bagging is of the type described in the utility model of Chinese origin CN206800513U of CHINA NORTH ENERGY CONSERVATION AND ENVIRONMENT PROT CO LTD which describes a Fog Water Collector device that is suitable for off-roading in nature, published on 26/07/2017; it comprises a frame for fixing the collector network, where said frame is rigid with a lower channel and where the panel is mounted on a tripod that can be placed anywhere and has a positioning wing that makes the panel always perpendicular to the wind flow.

This solution has the advantage that a maximum and optimal tension of the mesh can effectively be achieved in the rigid frame that it has which can be achieved mainly because the construction scale is very small, since it is a device for domestic use and rather individual; it is not a large-scale collector, but for personal consumption. Its small size allows the mesh to be tensioned in an optimal working position, perhaps with specialized machinery, and also allows the device to be transported in an assembled state; however, this solution is not applicable for larger scales because as mentioned previously, it is not easy to move a large armed panel to distant and high installation points. On the other hand, their costs would also be enormous if you consider placing so many of these units to collect the same amount of water that a traditional collector offers.

Another solution present in the state of the art that addresses the problem of mesh bagging due to the effect of the wind is described in the Application WO2016062877A1 of German origin from WASSERSTIFTUNG and published on 28/04/2016; discloses a fog collector that collects humidity from the incoming air through two spaced meshes or grilles with a synthetic mesh behind which another rigid mesh is placed for the mechanical stabilization of the first mesh to prevent the collecting mesh from being torn by the wind; both meshes are fixed to the support structure with elastic connectors, that in turn, are attached to the mesh using hooks.

Although it highlights the rigid support mesh that is important to resist high-speed winds, it has the disadvantage that it increases the cost of the fog collector. The means of attachment to the support are points that individually pull the assembly formed by the collector mesh and the rigid mesh; this individual joining solution works here without generating folds thanks only to the presence of the rigid mesh. On the other hand, the rigid mesh prevents easy transfer to the installation area, especially considering that the optimized installation is with large panels.

As it is possible to see, there is no low-cost solution available with few pieces that facilitates its installation by not needing to carry out in situ the optimal maximum stretching of the mesh through the connecting elements with the support structure; therefore, the present invention overcomes the problems of the state of the art meeting the requirements of an economical solution, providing a mesh plane with a low margin of deformation that causes mesh bagging, thus improving the collection rate and at the same time, the invention allows it to be transported in folded or rolled form without losing the required elongation.

### DESCRIPTION OF THE INVENTION

The present invention is related to a fog water collector that improves the collection rate in environments subjected to strong winds, and at the same time facilitates its transfer and installation.

One of the objectives of the invention is to provide a fog water collector that prevents the bagging or loss of verticality of the fog capturing mesh.

An additional objective of the invention is to provide a fog water collector whose collecting mesh has a compensated geometry, so that when assembled the desired pretension for the mesh is obtained.

Another objective of the invention is to provide a low cost fog water collector with low manufacturing complexity.

Another objective of the invention is to provide a fog water collector that facilitates the transfer of the capturing component in a reduced state, occupying less surface or space than that used when it is already installed.

Another objective of the invention is to provide a fog water collector that facilitates the assembly of the capturing component on the support component.

Another objective of the invention is to provide a fog water collector that ensures homogeneous tension of the mesh in all its directions to reduce the tearing of the mesh at the points of attachment to the support.

Another objective of the invention is to provide a manufacturing method that allows forming the capturing component that is part of the fog water collector.

The invention relates to a fog water collector that has a capturing component capable of retaining water that is in the air in humid environments, and a support component on which the capturing component is mounted.

The fog water collector also comprises a collecting channel in its lower part and means for accumulating the collected water; however, said components are not part of what is claimed in the present application; as well as the support component of the collector, this being formed by at least two columns embedded in the ground where the collector is installed, distanced according to the size of the capturing component, between which support profiles or tensioners of the aforementioned capturing component may be laid.

The capturing component comprises a plane of woven mesh of the type known in the art, normally it is a knitted fabric in the form of a two-dimensional or three-dimensional net made of fibers or filaments, preferably of polymeric material.

The present invention proposes a solution that allows improving the fog water collection rate by reducing the gravitational loss of the captured water. This is achieved by avoiding deformation or bagging of the mesh due to the effect of the wind; knowing that this deformation or bagging is a consequence of insufficient and irregular stretching of the mesh once assembled before receiving wind loads. At the same time, insufficient and irregular pre-stretching of the mesh in large collectors occurs mainly due to the difficulty of stretching a mesh panel to the exact design size at the time of assembly.

The capturing component of the present invention assumes a final ideal geometry that is normally related to the support structure that is formed from pillars already founded in the final ground; this ideal geometry to be arranged between the support columns is not always achieved when the mesh must be tensioned in situ from scratch, especially because the type of mesh conventionally used for fog collectors has a very different elongation behavior between the fabric sense of the warp and the sense of the woof. In the present document is proposed that, by properly knowing the elongation capacity of each of the directions of the mesh, it is possible to establish a priori the final geometry, not only from the point of view of size and shape, but also from the ideal behavior of the tensioned component.

Thus, in the invention the shape and dimensions of the mesh to be achieved in the final assembly are defined and according to the intensity of the wind at the installation site, the level of pre-stretching necessary to control the deformations is determined and with it, the elongation of the mesh in each of its directions, warp and woof, with which it is possible to reduce its dimensions to compensate for the elongation and fix it in a pre-stretched state to the edge elements of the support structure, whose dimensions correspond to those of the final assembly.

To this end, the capturing component of the proposed collector comprises a mesh panel defined by opposing main faces and a perimeter edge that is fixed or stabilized in a pre-elongated state in a perimeter frame, where the frame although flexible, in the sense that is not rigid, but is not stretchable either.

The capturing component can have different geometric shapes, such as the traditional rectangle shape with two parallel sides; however, the invention may also be achieved through different shapes of the capturing component which may be, for example, square or polygonal in shape, such as a pentagonal, hexagonal shape or with another number of regular or irregular sides.

The perimeter frame is formed by stabilizing bands and mounting bands, where said bands are laminar bodies which, as mentioned above, are made of a non-extensible flexible material.

Said stabilizing bands are attached to said perimeter edge of the mesh, the latter being in a pre-elongated state; they are arranged on both sides of the mesh panel and extend strictly along the entire length of each of the pre-elongated sides of the mesh panel perimeter.

In a preferred embodiment, the stabilizing bands are made up of two equal laminar bodies, each one forming a band that is arranged parallel to each other and in direct contact with each of the main faces of the mesh panel along the length of its entire pre-elongated perimeter edge. Each of said laminar bodies has an internal face that is in direct contact with the mesh, an external face opposite to the previous one that faces outward, which have a defined width between a larger outer edge that adjoins the edge of the perimeter and a greater interior edge opposite to the former edge.

In another embodiment of the invention, said stabilizing bands are formed by a single laminar body folded in half and along itself defining a folded major edge that in turn is opposite to distal major edges; it has an internal face that is in direct contact with each of the main faces of the mesh panel and along its entire pre-elongated perimeter edge; an external face that faces outwards and has a defined width between the folded major edge and the distal major edges.

With this technique, the stabilization or fixation of the perimeter of the mesh in a pre-elongated state is achieved thanks to the fact that this elongated perimeter is fixed by fusion generating a sealing effect of the mesh between the two bands of non-extendable material; thus, it is a condition that the material of the stabilizing bands has an elastic module lower than the elastic module of the mesh.

The non-extendable flexible sheet material that makes up the stabilizing bands and the mounting bands is a sheet material that comprises polyvinyl chloride (PVC) and polyester; preferably, said material is a polyester fabric laminated with polyvinyl chloride (PVC). Meanwhile, the material that makes up the mesh panel is a polymer fiber fabric woven in an open weave that allows the flow of fog to pass through.

The fusion joint of the elongated mesh between the stabilizing bands receives at least one line of longitudinal reinforcing seam that ensures that the pieces remain together although eventually the sealing of the bands to the mesh made by means of fusion could come loose or peel off; similarly, the fusion is useful to temporarily fix both materials (mesh and bands) to generate the resistant and definitive bond in the sewing machine.

The presence of two stabilizing bands, one on each side of the mesh, ensures that the fixation of the elongated state of the mesh is maintained over time, especially considering that the capturing component will be subjected to strong traction, both at the time of assembly as during normal operation. In turn, both bands placed one on each side of the mesh facilitates the sewing process, ensuring that the mesh is homogeneously elongated when the assembly is sewn.

On the other hand, the mounting bands which are also part of the flexible frame of the capturing component play an interface role between the mesh with its stabilized pre-elongated perimeter and the mounting means on the support structure. The mounting bands are formed by a laminar body of the same non-extensible flexible material from which the stabilizing bands are formed, and also extend strictly along the entire length of each of the pre-elongated sides that make up the perimeter of the mesh panel.

The laminar body of the mounting bands is a body folded along itself on a longitudinal folding edge defining interior faces that have longitudinal portions distal to said folding edge that have corners at each end of said portions; the distal longitudinal portions are superimposed on the outside and along the entire length of the stabilizing bands and joined thereto with fusion means.

At the vertexes of the capturing component where there are two sides adjacent to each other, the mounting bands may have their corners overlapping each other or alternatively said corners may be cut at an angle, so that they do not overlap each other.

Said longitudinal portions of the mounting bands that join along the stabilizer bands represent a width that is less than the total width of the stabilizer bands, so that when they overlap outside the stabilizer bands they do not cover completely the outer faces of the stabilizing bands, but only a portion of them; preferably, said portion that they cover of the stabilizing bands corresponds to the outermost half or closest to the perimeter edge of the stabilizing bands.

On the one hand, with this it is possible to save material, and on the other, to allow the frame of the mesh panel not to lose flexibility, since only a smaller portion is the one that finally receives two layers of bands per side; this makes it easier for the capturing component, once made with the perimeter edge stabilized in a pre-elongated manner between the bands, to also be folded or rolled to facilitate its transportation without having lost the elongation of its perimeter.

In the mounting bands between the longitudinal folding edge and the distal longitudinal portions, a tubular area is defined with a longitudinal cavity like a pocket, that allows the passage of longitudinal elements for mounting the capturing component on the fog collector support component.

Said longitudinal mounting elements can be formed, among others, by rigid tubular profiles or tensioners formed by cables or slings, which when extended along the cavity of the mounting bands allow a homogeneous tension of the mesh to be exerted.

In an embodiment of the invention, said tubular area of the mounting bands may comprise a plurality of radial projections that intersect the longitudinal folding edge, where these projections allow radial access to the mounting element that runs along the longitudinal cavity of each mounting band.

In another embodiment of the invention, said tubular area of the mounting bands comprises a plurality of transverse perforations that intersect the longitudinal cavity; where these perforations allow mounting ropes to pass through and join the mounting element to the support structure.

Accessing said mounting element radially allows connectors to be added in order to join them to pillars or crossbars that are part of the support structure; so that this connection with the support structure does not occur only at the ends of the cavity from which the profile emerges, which could generate bending and cause a lack of tension in the central portions of each side of the mesh; on the contrary, by having traction connectors in intermediate areas between the ends of the profile allows the span between supports to be shortened and prevents all the force from being sustained only by the cavity of the mounting bands, allowing the bands and the mesh to maintain a straight line parallel to the pillars and crossbars of the supporting structure maximizing the capture surface.

In yet another possible embodiment of the mounting band, it is completely smooth without perforations or radial projections.

The essential job of keeping the mesh elongated falls on the stabilizing bands, while the mounting bands allow the pre-elongated and already stabilized perimeter to be joined to the mounting structure; so that at the time of assembling the capturing component it already has its perimeter edge in an elongated state; therefore, in the final assembly, force should only be exerted to position the capturing component with its sides as straight as possible, seeking the parallel with the columns and crossbars that are part of the support component; without needing to stretch homogeneously the perimeter of the mesh, since it is already elongated.

The fusion means that join the stabilizing bands with the pre-elongated perimeter edge of the mesh panel, and at the same time join the distal longitudinal portion of the mounting bands with the stabilizing bands, correspond to high frequency fusion. This type of sealing or fusion is through the formation of an electromagnetic field and pressure applied to the surfaces of the materials to be joined, causing the molecules within the material begin to stir which generates heat that causes the material to soften and merge; this allows external heat not to be applied, but rather to be generated within the material. After cooling the sealed surface under sustained pressure, the material is molten creating a weld that may be as strong as the surrounding material. One of the main advantages of applying this type of seal is that it allows the joining of several layers.

The sewing means that reinforce the union between the stabilizing bands with the pre-elongated perimeter edge of the mesh panel, correspond to at least one longitudinal sewing line preferably located in the remaining portion of the stabilizing bands where there is no overlapping with mounting bands; this must be the case since the mesh in the sealing or welding area suffers damage from the temperature of the sealing process.

As it is posible to see, the characteristic of sealing or fusing a flexible but non-extensible perimeter frame to the contour of the mesh, is what allows the capturing component to be manufactured with the fixed perimeter in a pre-elongated state already from its manufacturing location, which can then be comfortably transferred in a folded or rolled state to its installation location and that at the time of assembly it is not necessary to begin there to elongate the mesh from scratch to give it the desired geometry, dimension and tension; but it will only be necessary to exert even tension on the contours, so that the central area of the mesh panel is stretched, thereby achieving a homogeneous tension between the central area and the perimeter of the mesh, and thereby avoiding clearance margins in the mesh that could cause it to become bagged due to the wind. This union by fusion and sewing of the stabilizing bands with the perimeter of the mesh, in turn, generates a homogeneous distribution of the forces in all directions of the mesh.

The present invention also refers to the method of manufacturing the capturing component formed by the mesh panel and the perimeter flexible frame, where the method includes the steps of:
a) to dimension the mesh panel according to the elongation of its perimeter edge considering both the elongation in the direction of the warp and woof of the mesh panel. In the case of the mesh panel material, it has an approximate elongation between 10% to 30% in the warp direction and 0.5% to 2% in the woof direction.
b) to arrange a first stabilizing band with its internal face upwards and on it, to place one of the main faces of the mesh panel in direct contact, along one of the sides of the perimeter edge, said side being the perimeter edge of the mesh panel in pre-elongated state. This step allows to visualize the position of the elongated mesh edge with respect to the first stabilizing band, thereby ensuring that the mesh is not stretched and fused irregularly.
c) to apply fusion media with high frequency and pressure to the stabilizing band assembly and pre-elongated perimeter edge of the mesh panel already arranged in the previous step. This step generates the first union that allows the mesh to be at least partially stabilized in its frame.
d) to arrange a second stabilizing band (12) parallel to the first stabilizing band (12) and in direct contact with the main face (102) opposite to the sealed face in step b). This allows both stabilizing bands to be sealed together, trapping the mesh in a pre-elongated state.
e) to apply fusion means to the stabilizing band assembly (12) and side of the pre-elongated perimeter edge (101) of the mesh panel (10) plus the second stabilizing band (12). This step allows the edge of the mesh to be completely sealed in the pre-elongated state.
f) to make at least one sewing line (14) along the assembly formed by the two stabilizing bands (12) and the side of the perimeter edge (101) fixed in the elongated state. This step generates a reinforcing bond complementary to high-frequency fusion.
g) to repeat steps b, c, d, e and f on each of the remaining sides of the perimeter edge (101) of the mesh panel (10);
h) to arrange the mounting band (13) folded along itself, where its distal longitudinal portions (132) overlap the outer longitudinal half of the stabilizing band (12);
i) to apply fusion means to the assembly of the mounting band (13), first stabilizing band (12), elongated perimeter edge (101) of the mesh panel and the second stabilizing band (12);
j) to repeat steps “h” and “i” on each of the remaining sides of the perimeter edge (101) of the mesh panel (10).
When arranging the overlapping mounting band on the outer longitudinal half of the stabilizing band indicated in step “h”, the corners of the distal longitudinal portions of two adjacent sides of the perimeter edge of the mesh panel, overlap one on top of the other and sealed together.
In an alternative embodiment of step “h”, when arranging the overlapping mounting band on the outer longitudinal half of the stabilizing band, the corners of the distal longitudinal portions of two adjacent sides of the perimeter edge of the mesh panel, the corners are cut at 45°, so that the corners do not overlap.
The fog water collector just described together with the method of manufacturing its capturing component, presents a variety of technical advantages that respond to the objectives of the invention; thus, the formation of the capturing component from a pre-elongated mesh plane allows the mesh to be highly tensioned once mounted on the support component with a very low or almost zero clearance margin that causes bagging or loss of verticality of the fog capture mesh due to the effect of wind pressure; this feature, in turn, allows the collection rate to be improved since providing a mesh that is not bagged by the effect of the wind, means that there is no gravitational loss of the captured water drops ensuring that they descend to the bottom collector channel of the fog collector.

Since the invention has a non-extensible perimeter frame and, in turn, a mesh that is extendable in predictive parameters, it allows the final tensioned geometry to be defined before being mounted on the support component.

The arranging of a single mesh panel for each fog water collector, said panel being of large dimensions, but at the same time it has not involved complex structures of many modular pieces or double mesh, allows the fog water collector to be of low cost and of low manufacturing complexity.

The fact that the perimeter frame of the capturing component is made up of flexible but non-elastic components, allows that having the mesh pre-elongated and fixed in that state, it can be folded or rolled to facilitate its transfer to geographical areas that are difficult to access.

The arrangement of mounting bands that are made of flexible but non-extensible material allows the generation of tubular cavities to pass mounting profiles or tensioners, where said mounting bands are attached to the stabilizing bands and to the mesh in a stable manner, making this means that the step of assembling the collector does not involve starting to stretch the mesh from scratch, which requires high tension to prevent it from bagging; with this, the assembly is reduced to homogeneously stretching each of the sides of the perimeter already fixed in the elongated state.

The fact that the stabilizing bands and the mounting bands provide a continuous connection along the sides of the mesh allows a homogeneous distribution of forces, since the means of attachment to the support is not formed from individual points that can loosen or have a different tension between them; this can reduce the possibility of tearing the mesh at the points of attachment to the support.
Likewise, the manufacturing method allows the formation of a capturing component that has its sides fixed in a pre-elongated state, through a frame that although flexible, is not extensible.

### DESCRIPTION OF THE FIGURES

To achieve the objectives, the invention can be carried out in different ways, so the Figures exhibited herein are only illustrative and do not limit the scope of the invention, and multiple embodiments can be acquired as long as they are under a common inventive concept. Thus, a detailed description of the invention will be carried out in conjunction with the Figures that form an integral part of this presentation, where:

FIG. 1 shows an elevation view of an installation that has at least two of the capturing components of the invention mounted on a support structure.

FIG. 2 shows an elevation view of the capturing component of the fog water collector of the present invention.

FIG. 3 shows an isometric sectional view of a detail of the capturing component.

FIG. 4 shows an isometric sectional view of a detail of a first embodiment of the stabilizing bands of the capturing component.

FIG. 4 shows an isometric sectional view of a detail of a second embodiment of the stabilizing bands of the capturing component.

FIG. 6 shows a sectional profile view of a detail of the assembly formed by the mounting band, stabilizing bands and mesh panel.

FIG. 7 shows an elevation view of a corner detail of the capturing component according to a first embodiment of the invention.

FIG. 8 shows an elevation view of a corner detail of the capturing component according to a second embodiment of the invention.

FIG. 8 shows an isometric sectional view of a detail of the capturing component according to a second embodiment of the mounting band of the invention.

FIG. 9 shows a sectional profile view of a detail of the assembly formed by the mounting band, the stabilizing band according to a second embodiment and the mesh panel.

FIG. 10 shows an isometric sectional view of a detail of the assembly formed by the mounting band in a first embodiment, stabilizing bands and mesh panel.

FIG. 11 shows an isometric sectional view of a detail of the assembly formed by the mounting band in a second embodiment, stabilizing bands and mesh panel.

FIG. 12 shows an isometric sectional view of a detail of the assembly formed by the mounting band in a third embodiment, stabilizing bands and mesh panel.

### DETAILED DESCRIPTION OF THE INVENTION

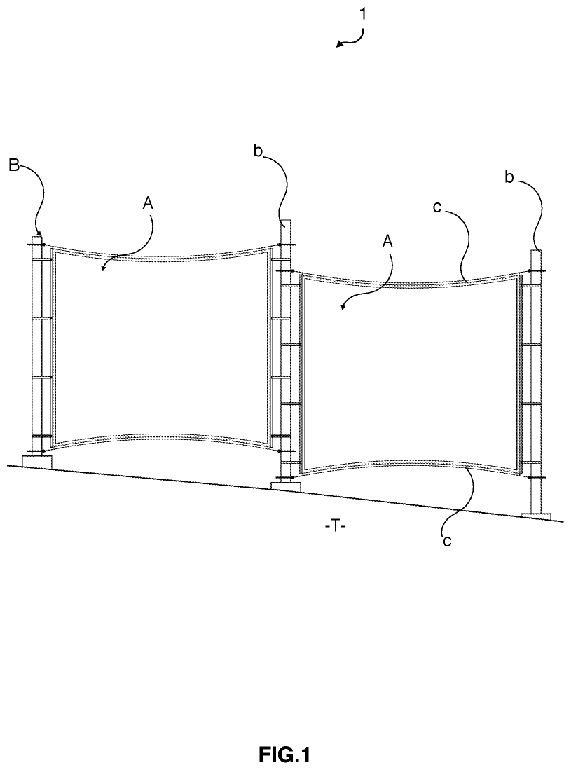

As can be seen in FIG. 1, the fog water collector (1) is made up of a capturing component (A) of the type formed by a mesh and a support component (B) in which the capturing component (A) is mounted; said support component (B) comprises at least two vertical columns (b) cemented to the ground (T) and at least two transverse elements or crossbars (c) extended between the columns (b). FIG. 1 shows a modular installation that comprises at least two capturing components (A) supported on a common central column (b) and a column (b) on each side.

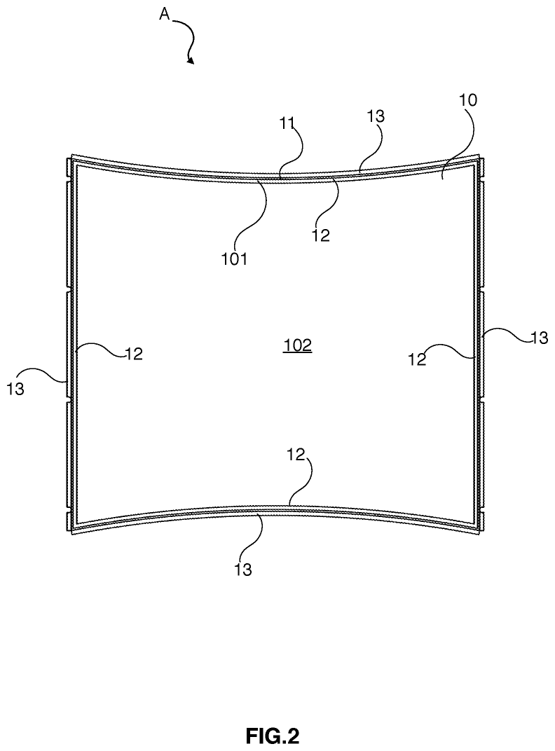

As best seen in FIG. 2, the capturing component (A) comprises a mesh panel (10) with main faces (102) that have a perimeter edge (101) fixed in a pre-elongated state in a flexible perimeter frame (11) which is formed by stabilizing bands (12) and mounting bands (13).

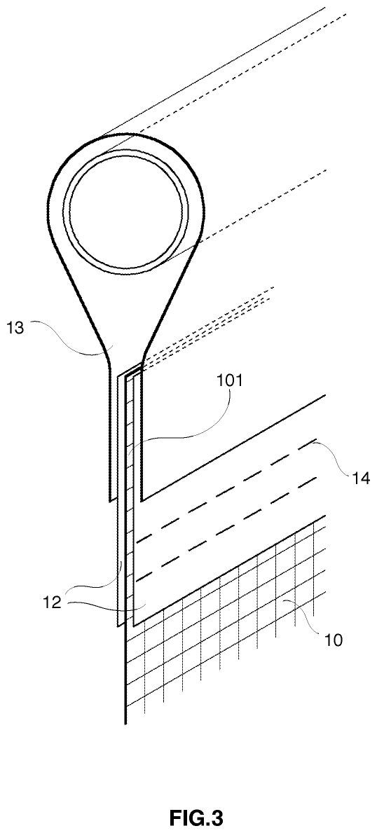

As seen in FIG. 3, the stabilizing bands (12) are attached to the mesh panel (10) by high frequency fusion means and at least one longitudinal seam line (14); the mounting bands (13) are, in turn, joined to said stabilizing bands (12) also by high frequency fusion means; where the material of the stabilizing bands (12) and the mounting bands (13) has a module of elasticity lower than the module of elasticity of the mesh panel material (10); the stabilizing bands (12) and the mounting bands (13) are made of a non-extensible flexible sheet material; said material being, preferably, a polyester fabric laminated with polyvinyl chloride (PVC) and the material that makes up the mesh panel (10) is a polymer fiber fabric woven in an open weave.

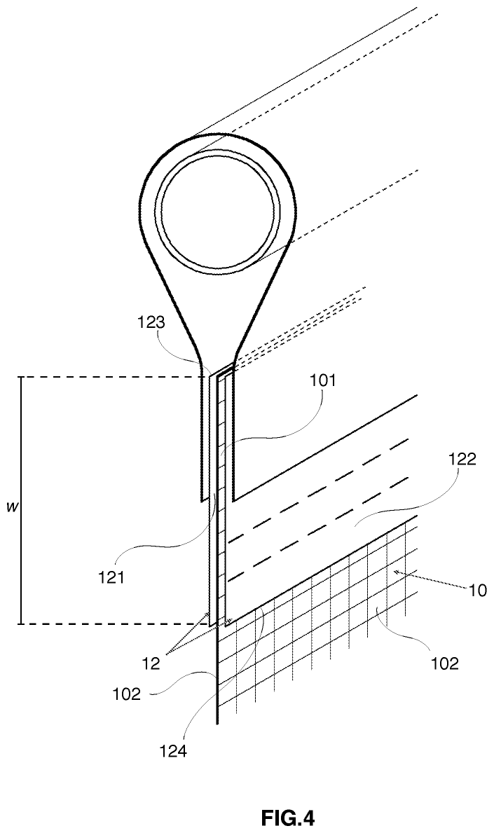

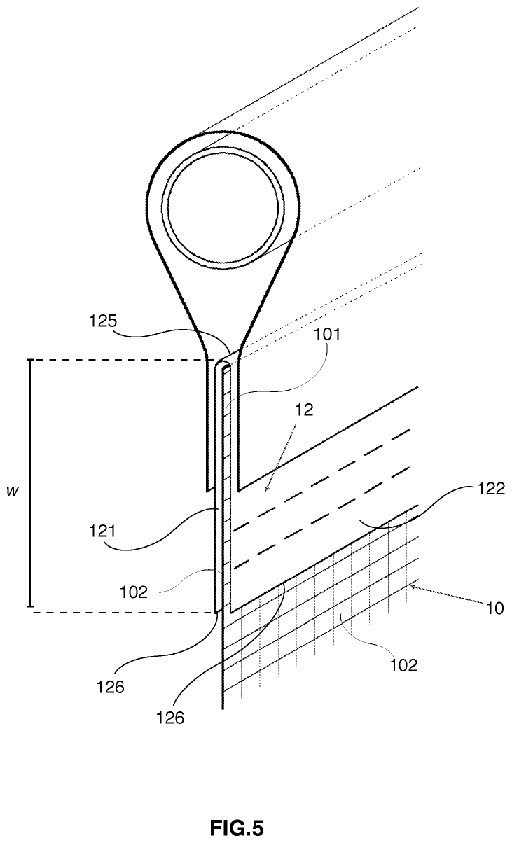

With reference to FIG. 4 which shows a first embodiment of the stabilizing bands (12), said stabilizing bands (12) are made up of two equal laminar bodies that have an internal face (121) and an external face (122) with a width (w) defined between an outer major edge (123) and an inner major edge (124); said internal faces (121) of the two bands (12) being arranged parallel to each other and in direct contact with each of the main faces (102) of the mesh panel (10) and along its entire pre-elongated perimeter edge (101).

In a second embodiment of the stabilizing bands (12) shown in FIG. 5, the stabilizing bands (12) are made up of a single laminar body folded in half and along itself defining a folded major edge (125) opposite some distal major edges (126); it has an internal face (121), an external face (122) and has a defined width between the folded major edge (125) and the distal major edges (126); said inner face (121) of the band being arranged in direct contact with each of the main faces (102) of the mesh panel (10) and along its entire pre-elongated perimeter edge (101).

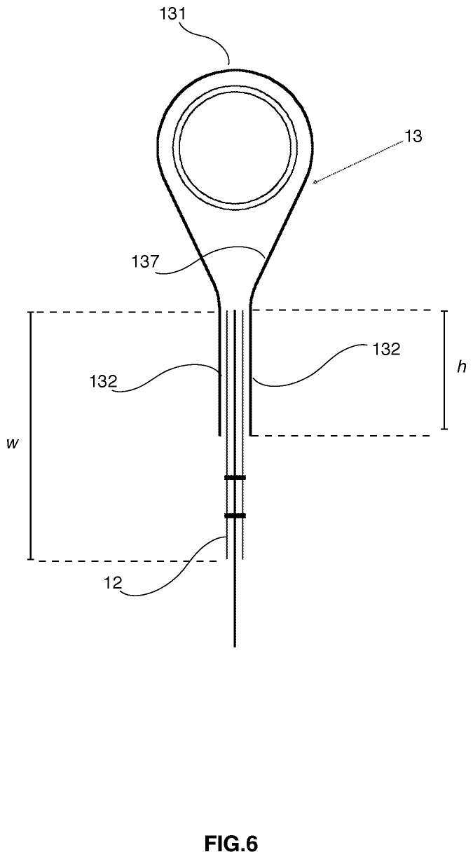

As illustrated in FIG. 6, the mounting bands (13) are formed by a body of a non-extensible flexible sheet material, folded along itself at a longitudinal folding edge (131) defining an interior face (137) that has longitudinal portions (132) distal to said folding edge (131) which have corners (138) and are joined with fusion means along each of said stabilizing bands (12). Said longitudinal portions (132) of the mounting bands (13) that are joined along the stabilizing bands (12) have a width (h) that is less than the width (w) of the stabilizing bands (12).

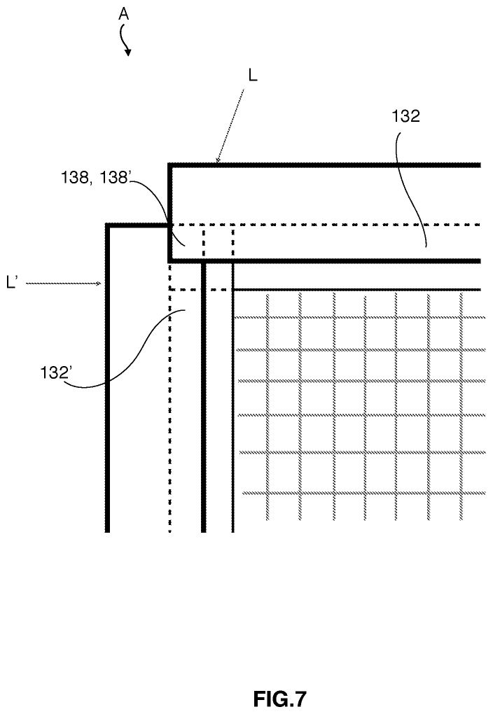

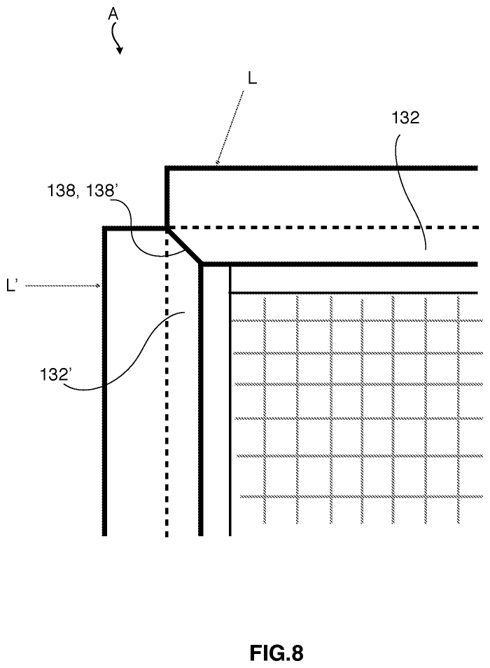

In said mounting bands (13), as illustrated in an embodiment shown in FIG. 7, when the corners (138, 138′) of the longitudinal portions (132, 132′) of two adjacent sides (L) and (L′) of the capturing component (A) meet, said corners (138, 138′) overlap one on top of the other and are sealed together. In another embodiment of the mounting bands (13), as illustrated in an embodiment shown in FIG. 8, when the corners (138, 138′) of the longitudinal portions (132, 132′) of two adjacent sides (L) and (L′) of the capturing component (A) meet, said corners (138, 138′) are beveled at an angle, so that they do not overlap each other.

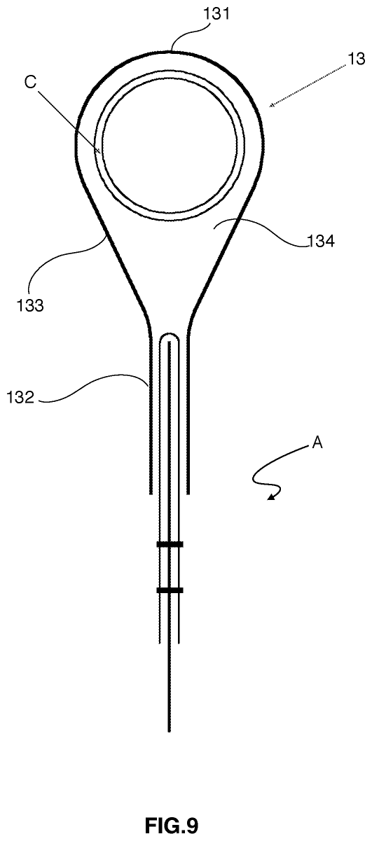

As seen in FIG. 9 in the mounting bands (13), between the longitudinal folding edge (131) and the distal longitudinal portions (132), a tubular area (133) is defined with a longitudinal cavity (134) which allows the passage of elements (C) for mounting the capturing component (A) on the support component (B) (not illustrated).

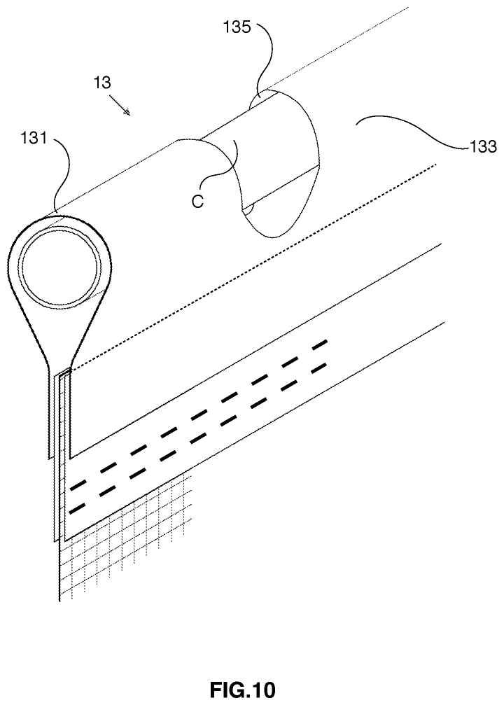

In one embodiment of the mounting band (13) as illustrated in FIG. 10, said tubular area (133) comprises a plurality of radial projections (135) that intersect the longitudinal folding edge (131) to have radial access to the mounting elements (C).

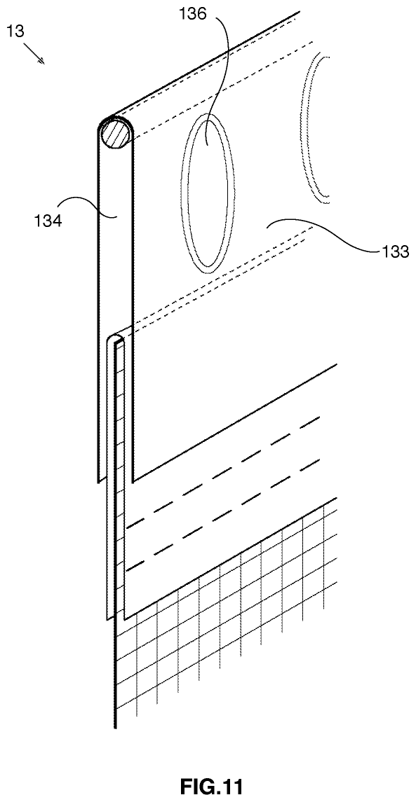

In another embodiment of the mounting band (13) as illustrated in FIG. 11, said tubular area (133) comprises a plurality of transverse perforations (136) that intersect the longitudinal cavity (134).

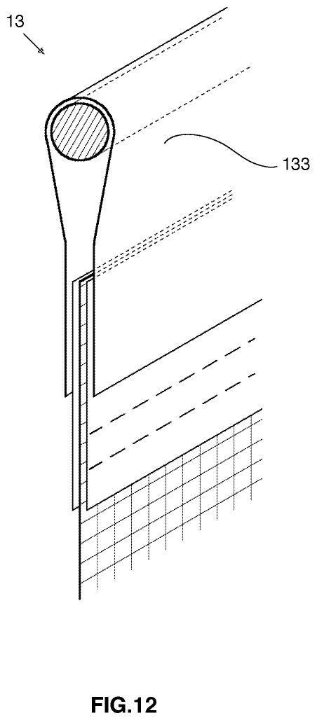

In yet another embodiment of the mounting band (13) as illustrated in FIG. 12, said tubular area (133) is a continuous surface sheet.

The invention also includes the method of manufacturing the capturing component (A), which includes the steps of:
a) to dimension the mesh panel (10) according to the elongation of its perimeter edge (101) considering both the elongation in the direction of the warp and the woof of the mesh panel (10);
b) to arrange a first stabilizing band (12) with its internal face (121) in direct contact with one of the main faces (102) of the mesh panel (10), along one of the sides of the perimeter edge (101), said side of the perimeter edge (101) of the mesh panel (10) being in a pre-elongated state;
c) to apply fusion means to the stabilizing band assembly (12) and pre-elongated perimeter edge (101) of the mesh panel (10);
d) to arrange a second stabilizing band parallel to the first stabilizing band (12) and in direct contact with the main face (102) opposite to the face sealed in step b);
e) to apply fusion means to the stabilizing band assembly (12) and side of the pre-elongated perimeter edge (101) of the mesh panel (10) plus the second stabilizing band (12);

f) to make at least one sewing line (14) along the assembly formed by the two stabilizing bands (12) and the side of the perimeter edge (101) fixed in the elongated state; g) to repeat steps b, c, d, e and f on each of the remaining sides of the perimeter edge (101) of the mesh panel (10);
h) to arrange the mounting band (13) folded along itself, where its distal longitudinal portions (132) overlap the outer longitudinal half of the stabilizing band (12);

i) to apply fusion means to the assembly of the mounting band (13), first stabilizing band (12), elongated perimeter edge (101) of the mesh panel and the second stabilizing band (12);
j) to repeat steps “h” and “i” on each of the remaining sides of the perimeter edge (101) of the mesh panel (10).

When arranging the mounting band (13) superimposed on the outer longitudinal half of the stabilizing band (12), the corners (138) of the distal longitudinal portions (132) of two adjacent sides of the perimeter edge (101) of the mesh panel (10), overlap one on top of the other and are sealed together.

In another alternative, when arranging the mounting band (13) superimposed on the outer longitudinal half of the stabilizing band (12), the corners (138) of the distal longitudinal portions (132) of two adjacent sides of the perimeter edge (101) of the mesh panel (10) are cut at an angle, so that the corners (138) do not overlap each other.

The fusion means correspond to high frequency fusion. The sewing means that join the stabilizing bands (12) with the pre-elongated perimeter edge (101) of the mesh panel (10) correspond to at least one longitudinal sewing line (14).

The non-extensible flexible laminar material that makes up the stabilizing bands (12) and the mounting bands (13) is preferably a polyester fabric laminated with polyvinyl chloride (PVC). The material that makes up the mesh panel (10) is a polymer fiber fabric woven in an open weave.

1. Fog water collector (1), consisting of a capture component (A) of the type formed by a mesh and a support component (B) on which the capture component (A) is mounted; capable of reducing the gravitational loss of the captured water by avoiding the bagging of the mesh (M) and facilitating its transfer in a folded or rolled state; CHARACTERIZED in that the capturing component (A) comprises a mesh panel (10) with main faces (102) that have a perimeter edge (101) fixed in a pre-elongated state in a flexible perimeter frame (11) formed by stabilizing bands (12) and mounting bands (13), the stabilizing bands (12) being made of a non-extensible flexible sheet material that are joined by means of fusion and a seam reinforcement to said perimeter edge (101) in a pre-elongated state; meanwhile, the mounting bands (13) are formed by a body of a non-extensible flexible laminar material folded along itself in a longitudinal folding edge (131) defining interior faces (137) that have longitudinal portions (132) distal to said folding edge (131) which are joined with fusion means along each of said stabilizing bands (12); and where the material of the stabilizing bands (12) and the mounting bands (13) have a lower elasticity module than the elasticity module of the mesh panel material (10).

2. The fog water collector (1) according to claim 1, characterized in that the non-extensible flexible laminar material that makes up the stabilizing bands (12) and the mounting bands (13), is a material that comprises polychloride vinyl (PVC) and polyester.

3. The fog water collector (1) according to claim 2, characterized in that said material is preferably a polyester fabric laminated with polyvinyl chloride (PVC).

4. The fog water collector (1) according to claim 1, characterized in that the material that makes up the mesh panel (10) is a polymeric fiber fabric woven in an open weave.

5. The fog water collector (1) according to claim 1, characterized in that the stabilizing bands (12) are made up of two equal laminar bodies that have an internal face (121) and an external face (122) with a width defined between a larger outer edge (123) and a larger inner edge (124), said inner faces (121) of the two bands (12) being arranged parallel to each other and in direct contact with each of the main faces (102) of the mesh panel (10) and along its entire pre-elongated perimeter edge (101).

6. The fog water collector (1) according to claim 1, characterized in that the stabilizing bands (12) are made up of a single laminar body folded in half and along itself defining a larger folded edge (125 ), in turn opposite to some distal major edges (126); it has an internal face (121) and an external face (122), and has a defined width between the folded major edge (125) and the distal major edges (126); said inner face (121) of the band being arranged in direct contact with each of the main faces (102) of the mesh panel (10) and along its entire pre-elongated perimeter edge (101).

7. The fog water collector (1) according to claim 1, characterized in that said longitudinal portions (132) of the mounting bands (13) that are joined along the stabilizing bands (12), have a width (h) which is less than the width (w) of the stabilizing bands (12).

8. The fog water collector (1) according to claim 7, characterized in that said longitudinal portions (132) have corners (138), and when the longitudinal portions (132) of two adjacent sides of the capturing component (A) meet, said corners are superimposed on top of each other and sealed together.

9. The fog water collector (1) according to claim 1, characterized in that in the mounting bands (13) between the longitudinal folding edge (131) and the distal longitudinal portions (132) a tubular area is defined (133) with a longitudinal cavity (134) that allows the passage of longitudinal elements (C) for mounting the capture component (A) on the support component (B) of the collector (1).

10. The fog water collector (1) according to claim 9, characterized in that said tubular area (133) comprises a plurality of radial projections (135) that intersect the longitudinal folding edge (131).

11. The fog water collector (1) according to claim 9, characterized in that said tubular area (133) comprises a plurality of transverse perforations (136) that intersect the longitudinal cavity (134).

12. The fog water collector (1), according to claim 9, characterized in that said tubular area (133) is a sheet with a continuous surface.

13. The fog water collector (1) according to claim 1, characterized in that the fusion means that join the stabilizing bands (12) with the pre-elongated perimeter edge (101) of the mesh panel (10) and at the same time they join the distal longitudinal portion (132) of the mounting bands (13) with the stabilizing bands (12), correspond to high frequency fusion.

14. The fog water collector (1) according to claim 1, characterized in that the sewing means reinforce the union between the stabilizing bands (12) with the pre-elongated perimeter edge (101) of the mesh panel (10), and correspond to at least one longitudinal seam line (14).

15. Method of manufacturing a capture component (A) of a fog water collector (1), where the capture component (A) comprises a mesh panel (10) with main faces (102) that have a perimeter edge (101) fixed in a pre-elongated state in a flexible perimeter frame (11), which is formed by stabilizing bands (12) and mounting bands (13); the stabilizing bands (12) being made of a non-extensible flexible sheet material that are joined by means of fusion and sewing, to said perimeter edge (101) in a pre-elongated state; meanwhile, the mounting bands (13) are formed by a body of a non-extensible flexible sheet material, folded along itself defining a longitudinal folding edge (131) and distal longitudinal portions (132) opposite said folding edge (131), which are joined with fusion means along each of said stabilizing bands (12); and where the material of the stabilizing bands (12) and the mounting bands (13) has a lower elasticity module than the elasticity module of the mesh panel material (10); the manufacturing method CHARACTERIZED in that it includes the steps of:
a) dimensioning the mesh panel (10) according to the elongation of its perimeter edge (101) considering both the elongation in the direction of the warp and woof of the mesh panel (10);
b) arranging a first stabilizing band (12) with its internal face (121) in direct contact with one of the main faces (102) of the mesh panel (10) along one of the sides of the perimeter edge

(101) said side of the perimeter edge (101) of the mesh panel (10) being in a pre-elongated state;
c) applying fusion means to the stabilizing band assembly (12) and pre-elongated perimeter edge (101) of the mesh panel (10);
d) arranging a second stabilizing band parallel to the first stabilizing band (12) and in direct contact with the main face (102) opposite to the face sealed in step b);
e) applying fusion means to the stabilizing band assembly (12) and side of the pre-elongated perimeter edge (101) of the mesh panel (10) plus the second stabilizing band (12);
f) making at least one sewing line (14) along the assembly formed by the two stabilizing bands (12) and the side of the perimeter edge (101) fixed in the elongated state;
g) repeating steps b, c, d, e and f on each of the remaining sides of the perimeter edge (101) of the mesh panel (10);
h) arranging the mounting band (13) folded along itself, where its distal longitudinal portions (132) overlap the outer longitudinal half of the stabilizing band (12);
i) applying fusion means to the assembly of the mounting band (13), first stabilizing band (12), elongated perimeter edge (101) of the mesh panel and the second stabilizing band (12);
j) to repeat steps “h” and “i” on each of the remaining sides of the perimeter edge (101) of the mesh panel (10).

16. The method of manufacturing a capture component of a fog water collector according to claim 15, characterized in that at the time of arranging the mounting band (13) superimposed on the outer longitudinal half of the stabilizing band (12), the corners (138) of the distal longitudinal portions (132) of two adjacent sides of the perimeter edge (101) of the mesh panel (10), overlap one on top of the other and are sealed together.

17. The method of manufacturing a capture component of a fog water collector according to claim 15, characterized in that at the time of arranging the mounting band (13) superimposed on the outer longitudinal half of the stabilizing band (12), the corners (138) of the distal longitudinal portions (132) of two adjacent sides of the perimeter edge (101) of the mesh panel (10) are cut at an angle, so that the corners (138) do not overlap each other.

18. The method of manufacturing a capture component of a fog water collector according to claim 15, characterized in that the fusion means correspond to high frequency fusion.

19. The method of manufacturing a capture component of a fog water collector according to claim 15, characterized in that the sewing means that join the stabilizing bands (12) with the pre-elongated perimeter edge (101) of the mesh panel (10) correspond to at least one longitudinal seam line

20. The method of manufacturing a capture component of a fog water collector according to claim 15, characterized in that the non-extensible flexible sheet material that makes up the stabilizing bands (12) and the mounting bands (13) is a material composed of polyvinyl chloride (PVC) and polyester.

21. The method of manufacturing a capture component of a fog water collector according to claim 15, characterized in that the material is preferably a polyester fabric laminated with polyvinyl chloride (PVC).

22. The method of manufacturing a capture component of a fog water collector according to claim 15, characterized in that the material that makes up the mesh panel (10) is a polymeric fiber fabric woven in an open weave that has an approximate elongation of 10% to 30% in the warp direction and 0.5% to 2% in the woof direction.
